(19) United States
(12) Patent Application Publication
(10) Pub. No.: US 2015/0097773 A1
(43) Pub. Date: Apr. 9, 2015

(54) METHOD FOR ACTIVATING AN APPLICATION AND SYSTEM THEREOF

(71) Applicant: Cho Yi Lin, New Taipei City (TW)

(72) Inventors: Ben Kai Liao, Taipei City (TW); Yu Shuang Hua, Taipei City (TW); Shao Wei Huang, Taipei City (TW); Shih Fong Yang, Taipei City (TW); Meng Hsi Wu, Taipei City (TW); Xiang Chi Lee, Taipei City (TW); Cho Yi Lin, Taipei City (TW); Chia Ching Lin, Taipei City (TW)

(21) Appl. No.: 14/048,536

(22) Filed: Oct. 8, 2013

(51) Int. Cl. G06F 3/0346

(52) U.S. Cl. CPC G06F 3/0346
USPC 345/158

(57) ABSTRACT

The disclosure is related to a method for activating an application. The method involves detecting a position status by using at least one sensor, determining whether the position status satisfies a predetermined condition, and executing an application corresponding to the position status when the position status satisfies a predetermined condition. The disclosure is also related to a system for activating an application. The system includes at least one sensor and a processor communicates with the at least one sensor. The sensor detects a position status of an electrical device and generates a detecting signal corresponding to the position status. The processor determines the position status of the electrical device in response to the detecting signal outputted from the sensor, and determines whether the position status satisfies a predetermined condition, and executing an application corresponding to the position status when the position status satisfies a predetermined condition.

### BACKGROUND

1. Technical Field

The disclosure relates to a method for activating an application and system thereof, and more particularly to a method for activating an application according to the position status of the electrical device in a space and system thereof.

2. Related Art

Advancement on manufacture technology for electrical products leads to launch of slim products. The technology advancement also improves the performance of the electrical products. Current mobile phones not only are equipped with communication function, but also have wireless network function and notebook function. Thus, smart phones integrating mobile phones and person digital assistance (PDA) are launched into the market. Users may use smart phones to send and receive emails, read stock market information, and remind himself/herself of time and location of the important appointment. Further, users may operate the smart phones having touchable display panel by way of finger touch on the screen. Users may have interaction with the smart phones.

The current smart phones adopt icons for operation. Each application is indicated by an icon. When the user intends to use the application, he/she may touch the icon on the screen and the application is then executed. However, as reliance on intelligent phones becomes prevalent, it is desirous to develop a convenient user interface for operation.

### SUMMARY

Exemplary embodiments of the disclosure disclose a method for activating an application and system thereof.

A method for activating an application, adapted to an electrical device, according to some embodiments of the disclosure comprising detecting a position status of the electrical device using at least one sensor; determining whether the position status of the electrical device conforms with a specific condition; and executing an application corresponding to the specific condition when the position status of the electrical device conforms with the specific condition.

A system for activating an application, adapted to an electrical device, according to some embodiments of the disclosure comprising at least one sensor for detecting a position status of the electrical device and outputting a sensing signal corresponding to the position status; and a processor for determining the position status of the electrical device in response to the sensing signal, determining whether the position status of the electrical device conforms with a specific condition, and executing an application corresponding to the specific condition when the position status of the electrical device conforms with the specific condition.

A computer product for being loaded by a machine and executing a method for activating an application, according to some embodiments of the disclosure, comprising a first program code for detecting a position status of the electrical device using at least one sensor; a second program code for determining whether the position status of the electrical device conforms with a specific condition; and a third program code for executing an application corresponding to the specific condition when the position status of the electrical device conforms with the specific condition.

For a fuller understanding of the nature and objects of the invention, reference should be made to the following detailed description taken in connection with the accompanying drawings.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic diagram of the system for activating an application according to the embodiment of the disclosure;

FIG. 2 is another schematic diagram of the system for activating an application according to the embodiment of the disclosure;

FIG. 3 is another schematic diagram of the system for activating an application according to the embodiment of the disclosure;

FIG. 4 is flow chart of the method for activating an application according to the embodiment of the disclosure;

FIG. 5A to FIG. 5D illustrates the operation of the embodiment of the disclosure;

FIG. 6A to FIG. 6D illustrates another operation of the embodiment of the disclosure;

FIG. 7A to FIG. 7D illustrates another operation of the embodiment of the disclosure;

FIG. 8A to FIG. 8D illustrates another operation of the embodiment of the disclosure;

FIG. 9A to FIG. 9D illustrates another operation of the embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The detailed characteristics and advantages of the disclosure are described in the following embodiments in details, the techniques of the disclosure can be easily understood and embodied by a person of average skill in the art, and the related objects and advantages of the disclosure can be easily understood by a person of average skill in the art by referring to the contents, the claims and the accompanying drawings disclosed in the specifications.

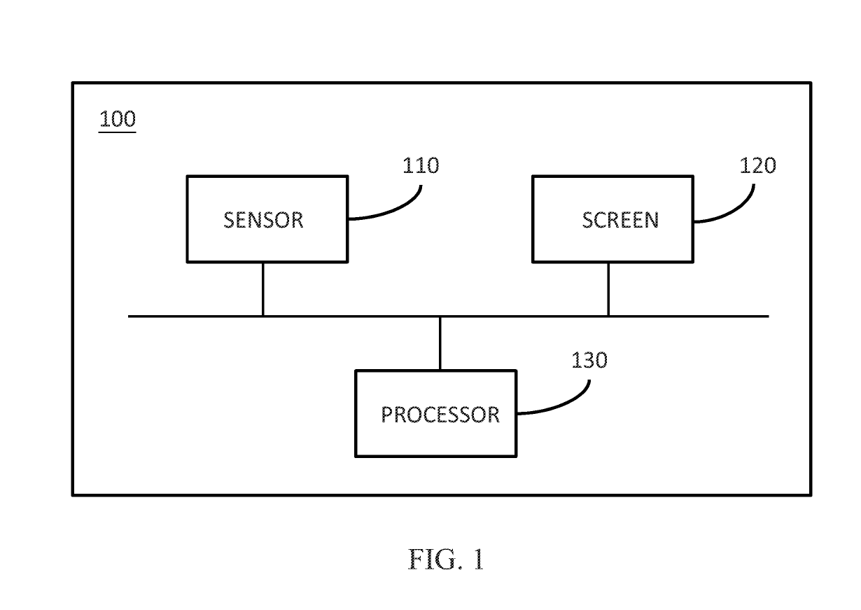

The method of the disclosure may be implemented by program code. When the program code is loaded into a machine and executed, the machine becomes a device for performing the method of the disclosure. FIG. 1 is a schematic diagram of the system for activating an application according to the embodiment of the disclosure. The system for activating an application according to the embodiment of the disclosure may be adapted to an electrical device, such as tablet computer, person digital assistance, intelligent phone, mobile phone, or mini notebook. The system 100 for activating an application according to the embodiment of the disclosure comprises at least one sensor 110, a screen 120 and a processor 130. The processor 130 executes the method for activating an application of the disclosure. The details are given in the following paragraphs.

The number of the sensor 110 is at least one, as illustrated in FIG. 1. The number of the type of the sensor may be implemented according to the design of the electrical device. The sensor 110 detects current the position status of the electrical device and outputs a sensing signal corresponding to the position status to the processor 130. The processor 130 is electrically connected to the sensor 130. The process 130, in response to the sensing signal 110, determines the position status of the electrical device, and determines whether the position status conforms to a specific condition. When the position status conforms to the specific condition, an application corresponding to the specific condition is executed. In the meanwhile, the screen 120 displays associated information, such as the icon of the application, the interface and related content. In some embodiments, the sensor 110 may adopt a G-sensor.

In another embodiment, the processor 130 further determines whether the position status of the electrical device 100 falls in an error range of the specific condition. When the position condition falls in the error range of the specific condition, the position status is determined to be in compliance with the specific condition.

When the position status conforms to the specific condition, the processor 130 determines whether the electrical device 100 maintains the current position status exceeds a period of time. When the electrical device 100 maintains the current position status exceeds a period of time, an application corresponding to the specific condition is executed. When the position status does not conform to the specific condition, the at least one sensor continues detecting the position status of the electrical device.

In some embodiments, a touchable screen may be adopted by way of combining the screen 12 and a touchable sensing device (not shown). The touchable sensing device includes at least one one-dimension sensor having a touchable surface for detecting the touch or movement on the surface of the input device, such as fingers or stylus pen.

In some embodiments, the specific condition includes the position status of the electrical device is in a first angle, a second angle, a third angle and a forth angle.

In other embodiments, the angles respectively have a difference of ninety degrees. The first angle is defined as the position status for the normal operation of the electrical device 100. The second angle is defined as the electrical device 100 clockwise rotates for ninety degrees from the first angle. The third angle defines the electrical device 100 clockwise rotates for 180 degrees from the first angle. The forth angle is defined as the electrical device 100 clockwise rotates for 270 degrees from the first angle. The embodiment adopts “degree” and “clockwise/counterclockwise” for the illustration of the position status of the electrical device. Actually, the position status is detected by the sensor 110 and determined by the processor 130. The first angle, the second angle, the third angle and the forth angle may also be referred as the first position, the second position, the third position, and the forth position respectively. These are also applicable for the following embodiments.

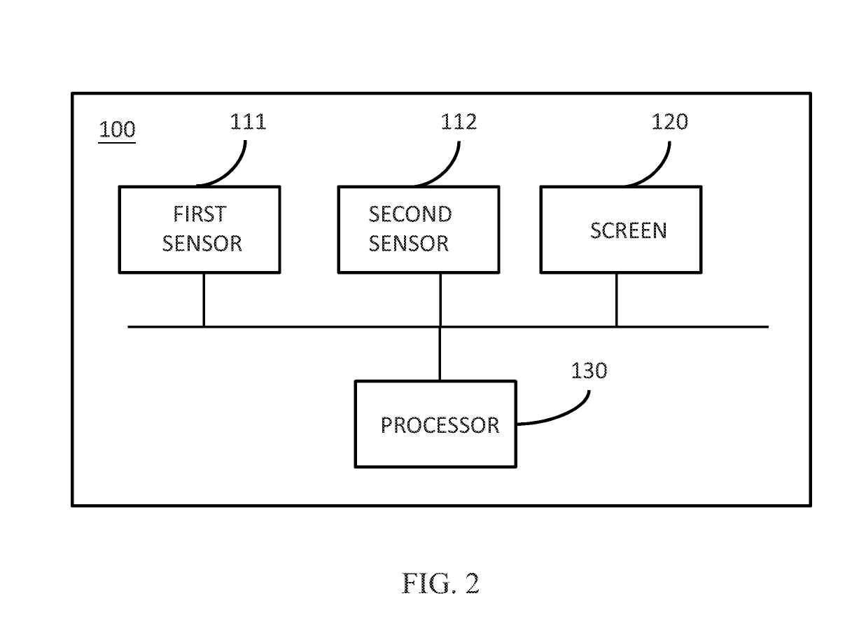

FIG. 2 illustrates another embodiment of the disclosure. The embodiment adopts two sensors, which are the first sensor 111 and the second sensor 112. The first sensor 111 and the second sensor 112 detect the current position status of the electrical device respectively and output the first sensing signal and the second sensing signal to the processor 130. The processor 130 is electrically connected to the first sensor 111 and the second sensor 112. The processor 130 determines the current direction and the angle of the electrical device in response to the first sensing signal from the first sensor 111 and the second sensing signal from the second sensor 112. Then the processor 130 further determines the current position status of the electrical device according to the obtained direction and angle. In this embodiment, the types of the first sensor 111 and the second sensor 112 are different. For example, the first sensor 111 adopts the G-sensor. The second sensor adopts the gyro meter or the magnetic sensor.

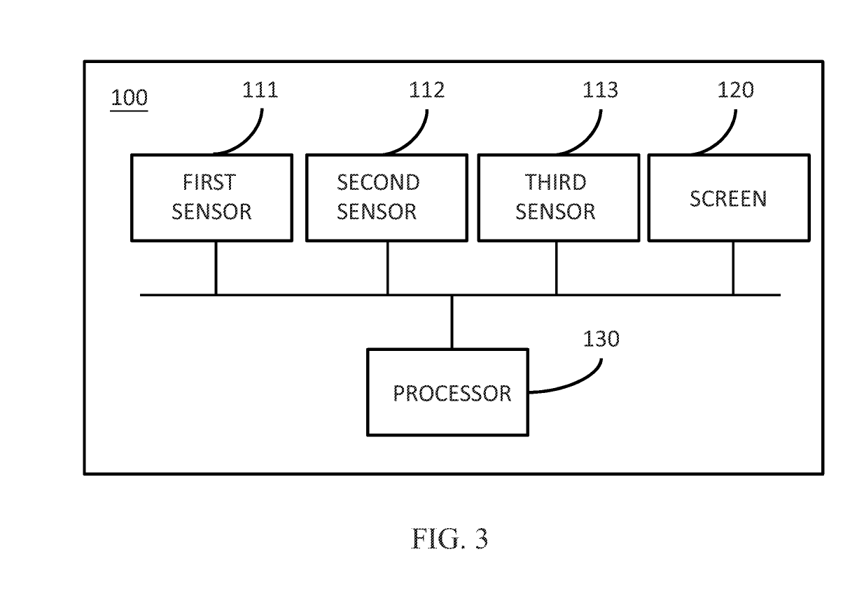

FIG. 3 illustrates another embodiment of the disclosure. The embodiment adopts three sensors, which are the first sensor 111, the second sensor 112, and the third sensor 113. The first sensor 111, the second sensor 112 and the third sensor 113 detect the current position status of the electrical device respectively and output the first sensing signal, the second sensing signal, and the third sensing signal to the processor 130. The processor 130 is electrically connected to the first sensor 111, the second sensor 112, and the third sensor 113. The processor 130 determines the current direction and the angle of the electrical device in response to the first sensing signal from the first sensor 111, the second sensing signal from the second sensor 112, and the third sensing single from the third sensor 113. Then the processor 130 further determines the current position status of the electrical device according to the obtained direction and angle. When the position status conforms to the specific condition, an application corresponding to the specific condition is executed. In this embodiment, the types of the first sensor 111, the second sensor 112, and the third sensor 113 are different. For example, the first sensor 111 adopts the G-sensor. The second sensor 112 adopts the gyro meter. The third sensor 113 adopts the magnetic sensor.

Similarly, in another embodiment of FIG. 2 and FIG. 3, the processor 130 further determines whether the position status of the electrical device 100 falls in an error range of the specific condition. When the position condition falls in the error range of the specific condition, the position status is determined to be in compliance with the specific condition. When the position status conforms to the specific condition, the processor 130 determines whether the electrical device 100 maintains the current position status exceeds a period of time. When the electrical device 100 maintains the current position status exceeds a period of time, an application corresponding to the specific condition is executed. When the position status does not conform to the specific condition, the at least one sensor continues detecting the position status of the electrical device.

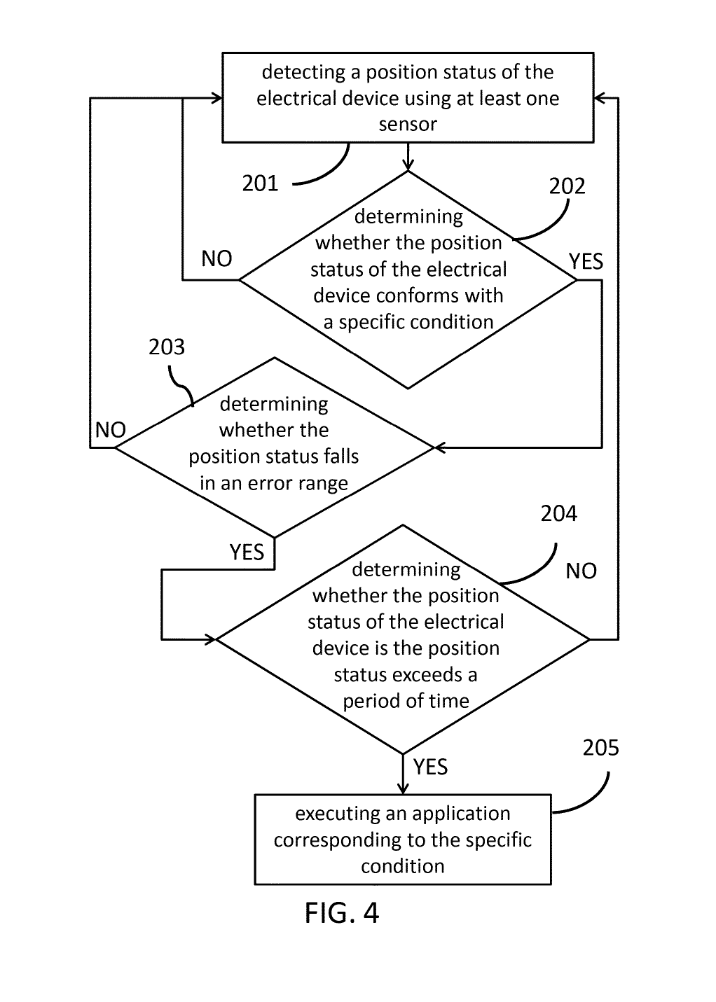

FIG. 4 shows the method of activating an application of the disclosure. The method of the disclosure may be applied to an electrical device, such as tablet computer, person digital assistance, intelligent phone, mobile phone, or mini notebook. First, a position status of the electrical device is detected by at least one sensor (step 201). Then whether the position status conforms to a specific condition is determined (step 202). When the current position status conforms to the specific condition, an application corresponding to the specific condition is executed (step 205). When the position status does not conform to the specific condition, the flow returns to the step 201. The at least one sensor continues detecting the operation angle of the electrical device. The operation angle may be defined as an angle in relative to a horizontal surface. In the step 201, the detection may be implemented by using the configuration of FIG. 1, FIG. 2 or FIG. 3.

In one embodiment, the specific condition includes the position status of the electrical device is in a first angle, a second angle, a third angle and a forth angle. In another embodiment, the angles respectively have a difference of ninety degrees. For example the first angle may be 0 degree. The second angle may be 90 degrees. The third angle may be 180 degrees. The forth angle may be 270 degrees. The specific condition in the embodiment indicates whether the position status conforms to the angle defined herein. When the quantity of the sensors is sufficient or the precision is available, the specific condition may include more angles, such as eight angles.

In one embodiment, the step of determining whether the position status conforms to the specific status further involves determining whether the position status falls in the error range of the specific condition (step 203). When the position status falls in the error range of the specific condition, the position status is determined to conform to the specific condition. When the position status does not fall in the error range of the specific condition, the flow returns to the step 201. The at least one sensor continues detecting the position status of the electrical device.

In one embodiment, when the current position status conforms to the specific condition, the flow further includes determining whether the electrical device maintains the position status exceeds a period of time. When the electrical device maintains the position status exceeds the period of time, the application corresponding to the specific condition is executed. If the electrical device does not maintain the position status exceeds the period of time, the flow returns to the step 201. The at least one sensor continues detecting the position status of the electrical device.

Before the step of 201, an activation instruction may be implemented in the system of the electrical device. When the activation instruction is executed, the aforementioned method of activating an application is then executed. In another embodiment, a hardware element may be implemented in the electrical device, such as the switch, for activating the aforementioned method.

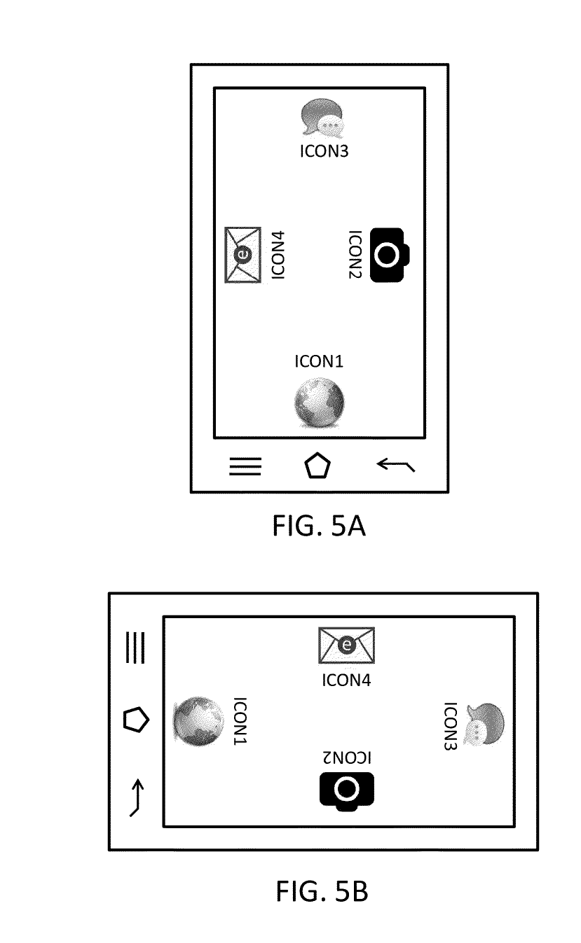

Refer to FIG. 5A to 5D, which illustrating the operation of the disclosure. FIG. 5A to 5D corresponds to the first angle, the second angle, the third angle and the forth angle respectively. The first angle to the forth angle is defined clockwise or counterclockwise. For example, the first angle, being 0 degree, is the position status that the electrical device operates normally. The second angle is 90 degrees, which is the degree that the electrical device rotates 90 degrees clockwise. The third angle is 180 degrees, which is the degree that the electrical device rotates 180 degrees clockwise. The forth angle is 90 degrees, which is the degree that the electrical device rotates 270 degrees clockwise. When the method is activated, the icons ICON1, ICON2, ICON3, and ICON4 as shown in FIG. 5A are displayed on the screen. Each angle corresponds to an executable application. For example, in this embodiment, the application corresponding to the first angle is the browser application. The icon corresponding to this application is ICON1. The application corresponding to the second angle is the camera application. The icon corresponding to this application is ICON2. The application corresponding to the third angle is the message application. The icon corresponding to this application is ICON3. The application corresponding to the forth angle is the e-mail application. The icon corresponding to this application is ICON4. In this embodiment, the icons on the screen do not rotate while the electrical device rotates.

FIG. 5A illustrates the normal operation state of the electrical device. The specific condition indicates the first angle, which is defined as 0 degree. The sensing signal is obtained through the aforementioned sensor. The processor determines the position status of the electrical device as being at the first angle in response to the sensing signal. The method of the disclosure further changes the color of the icon ICON1 for recognition. The color may not be presented in the drawing thus only description is used for illustration herein. In FIG. 5B, the electrical device rotates 90 degrees clockwise. The specific condition herein indicates the second angle from the first angle, which is defined as 90 degrees. The method of the disclosure further changes the color of the icon ICON2 for recognition. In FIG. 5C, the electrical device rotates 180 degrees from the first angle clockwise. The specific condition herein indicates the third angle, which is defined as 180 degrees. The icon ICON3 on the screen changes its color. In FIG. 5D, the electrical device rotates 270 degrees from the first angle clockwise. The specific condition herein indicates the forth angle, which is defined as 270 degrees. The icon ICON4 on the screen changes its color. Also, the electrical device may rotate 90 degrees counterclockwise.

It is appreciated from the drawings that the four icons are placed on the directions of the screen. When the position status of the electrical device is determined being at the first angle for a period of time and within the error range, the system of the electrical device executes the application corresponding to the first icon. Or when the position status of the electrical device is determined being at the third angle for a period of time and within the error range, the system of the electrical device executes the application corresponding to the third icon. It is appreciated from this embodiment that a user may rotate the electrical device such that the application to be executed is also rotated to the bottom of the screen. The system may determine the position status accordingly and determine the application to be executed. Then the system executes the corresponding application.

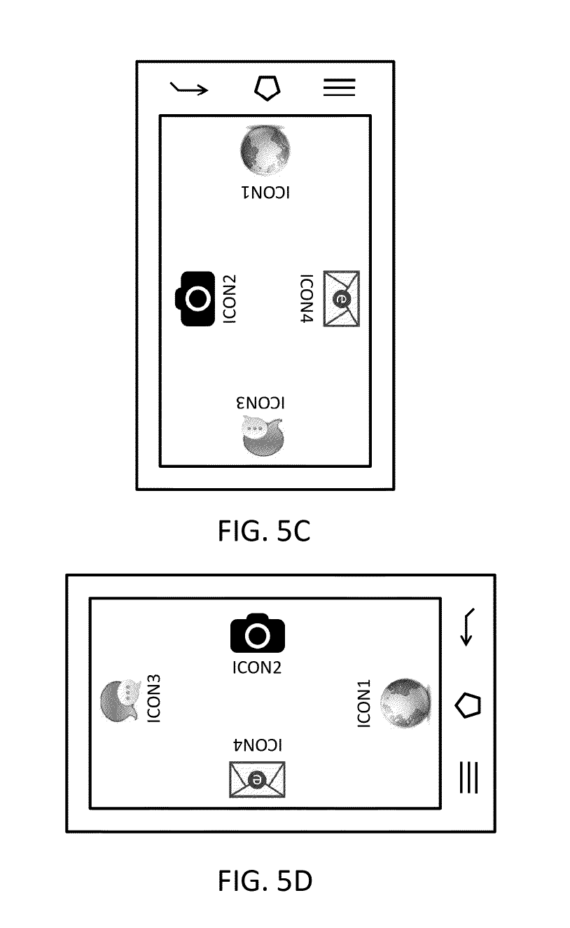

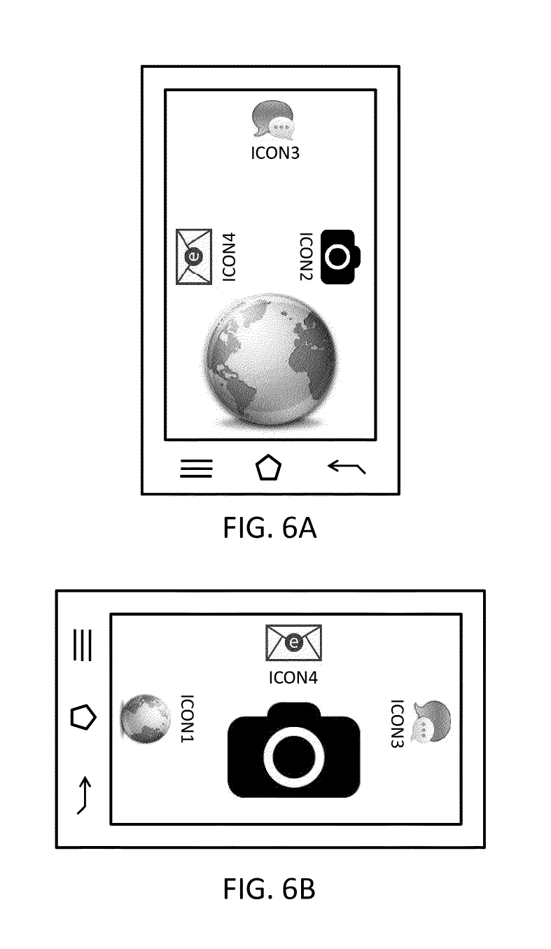

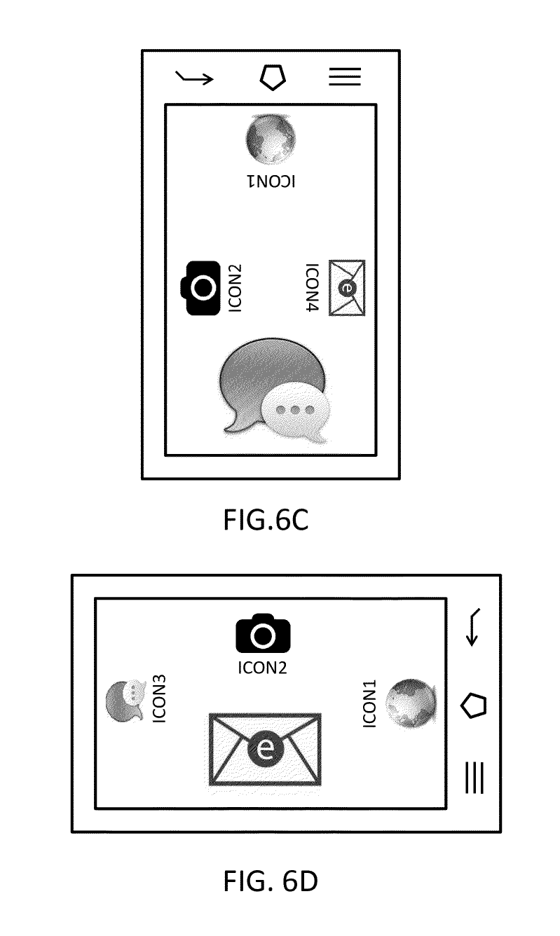

FIG. 6A to FIG. 6D illustrates another operation of the embodiment of the disclosure. The configuration of FIG. 6A to FIG. 6D is similar to that FIG. 5A to FIG. 5D is similar. In this embodiment, when the electrical device rotates to the corresponding angle, the corresponding icon is enlarged.

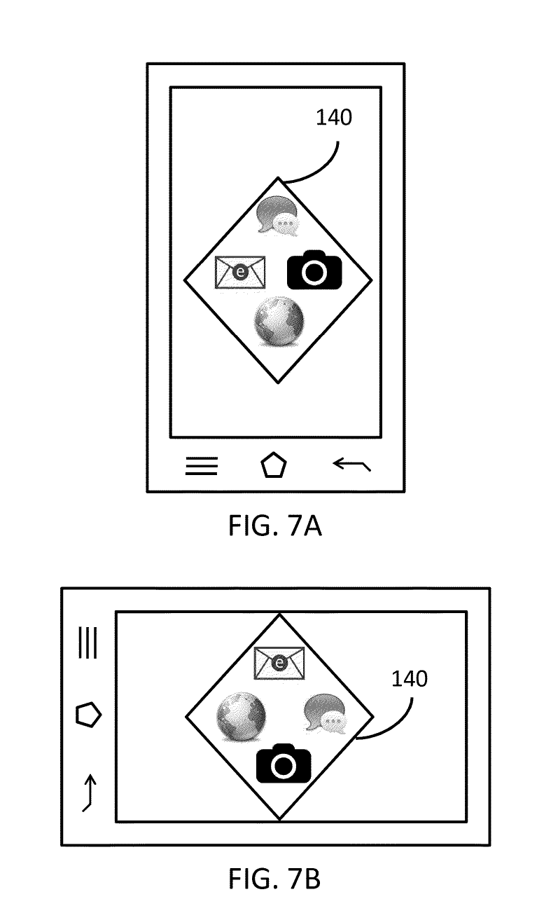

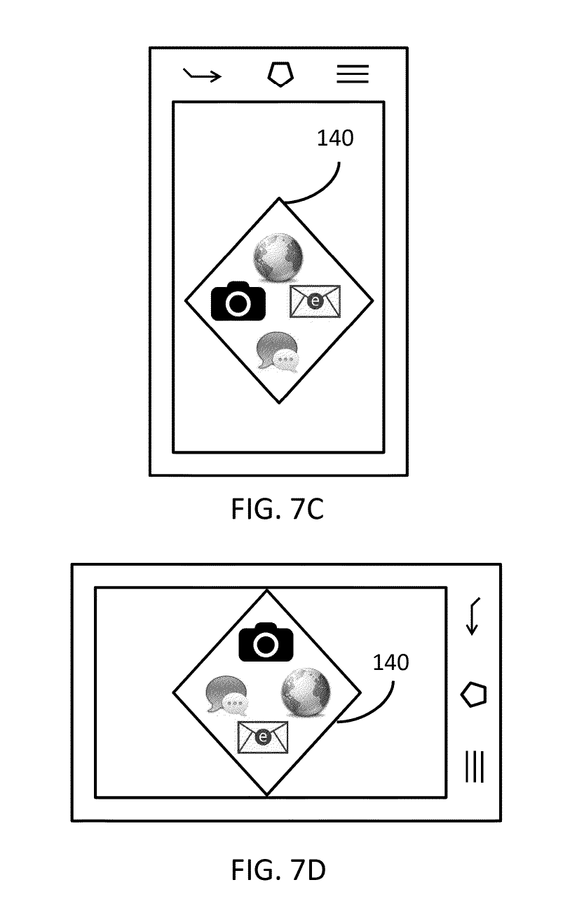

FIG. 7A to FIG. 7D illustrates another operation of the embodiment of the disclosure. The configuration of FIG. 7A to FIG. 7D is similar to that FIG. 5A to FIG. 5D is similar. In this embodiment, the icons are places in the center of the screen, and are highlighted by way of a specific means, such as the color block 140 in the screen. In this embodiment, when the electrical device rotates, the icons rotate with the electrical device. For example, when the electrical device rotates to the second angle, the icon ICON2 rotates to the bottom of the screen.

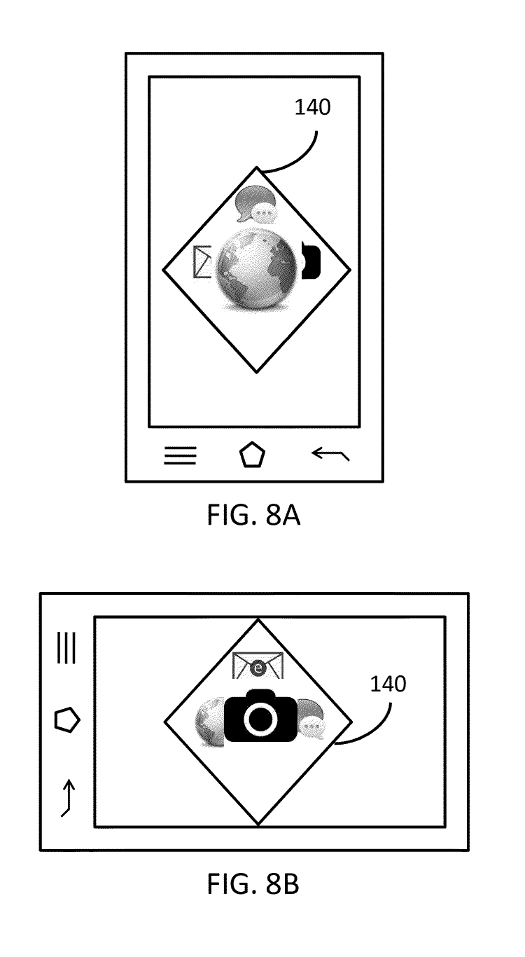

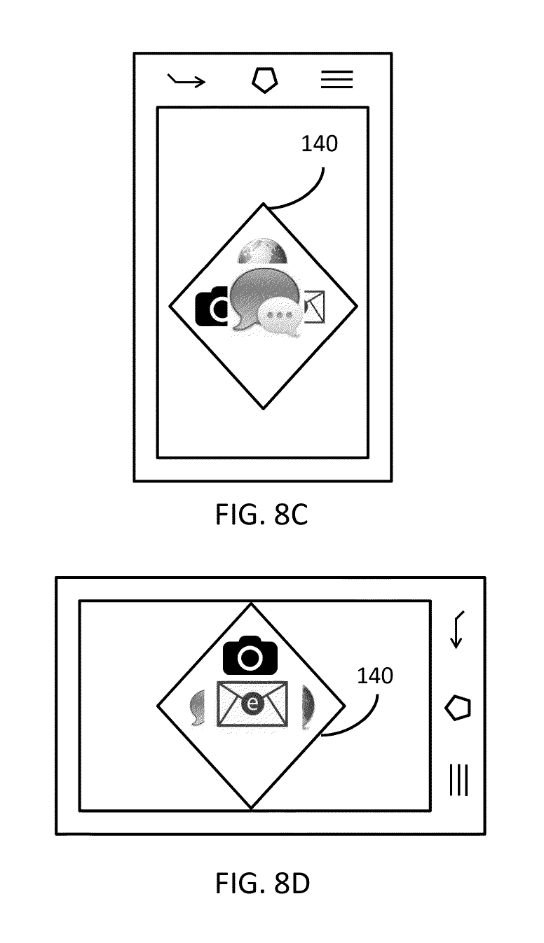

FIG. 8A to FIG. 8D illustrates another operation of the embodiment of the disclosure. The configuration of FIG. 8A to FIG. 8D is similar to that FIG. 7A to FIG. 7D is similar. In this embodiment, when the electrical device rotates to the corresponding angle, the corresponding icon is enlarged to be shown in the center of the screen.

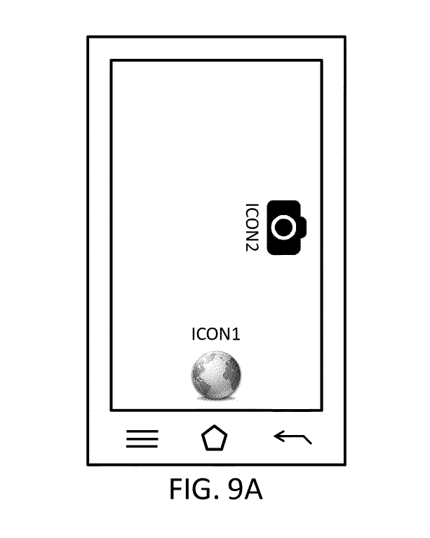

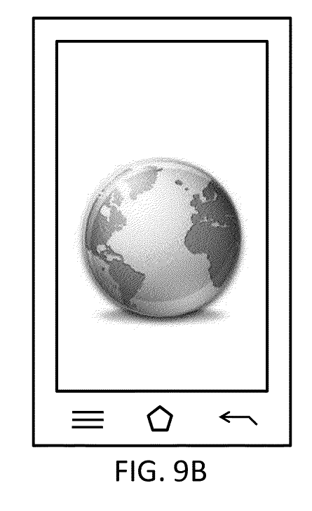

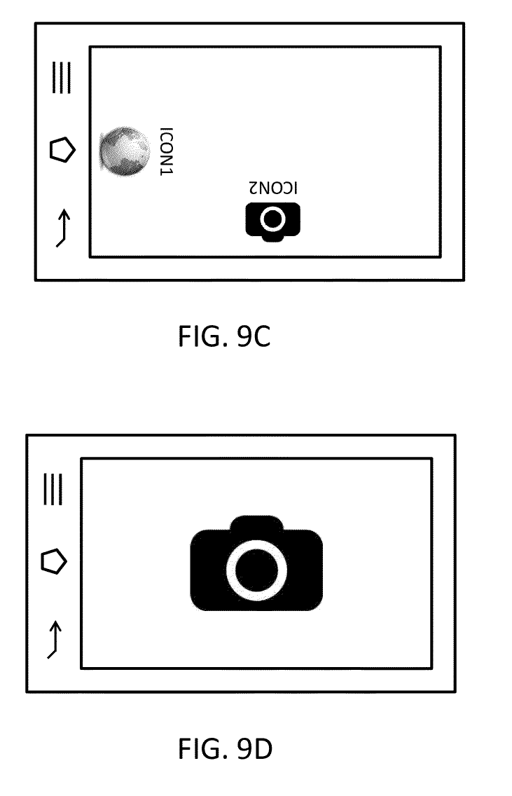

FIG. 9A to FIG. 9D illustrates another operation of the embodiment of the disclosure. The configuration of FIG. 9A to FIG. 9D is similar to that FIG. 5A to FIG. 5D is similar. In this embodiment, the applications are only at the first angle and the second angle. As shown in FIG. 9A, it is not necessary for the four angles to have corresponding applications. In this embodiment, when the activation method is executed, and the electrical device maintains at the first angle exceeding for a period of time, the corresponding icon is enlarged and the other icons disappear from the screen, as shown in FIG. 9B. Then the application corresponding to the enlarged icon is executed. When the electrical device rotates clockwise and maintains at the second angle exceeding for a period of time, as shown in FIG. 9C, the corresponding icon of the application, such as the camera icon as shown in FIG. 9D is enlarged in the center region of the screen and the corresponding application is executed.

Although the embodiments use four icons and four angles for illustration, the correspondence of the icons and the angles may change according to different situations, for example, two icons and two angles. When the sensor may detect slight angles, more than four angles may be adopted.

The method in the embodiments of the disclosure, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

The method and system for activating an application of the embodiments of the disclosure does not require touch on the screen to activate an application. Users rotate the electrical device and the corresponding application is executed. Thus the embodiments of the disclosure facilitate the operation to activate an application.

Note that the specifications relating to the above embodiments should be construed as exemplary rather than as limitative of the present invention, with many variations and modifications being readily attainable by a person skilled in the art without departing from the spirit or scope thereof as defined by the appended claims and their legal equivalents.

What is claimed is:

1. A method for activating an application, adapted to an electrical device, comprising:
detecting a position status of the electrical device using at least one sensor;
determining whether the position status of the electrical device conforms with a specific condition; and
executing an application corresponding to the specific condition when the position status of the electrical device conforms with the specific condition.

2. The method according to claim 1, wherein the specific condition comprises the position status of the electrical device is a first angle, a second angle, a third angle, and a forth angle.

3. The method according to claim 2, wherein the angles respectively have a difference of ninety degrees.

4. The method according to claim 1, wherein the step of determining whether the position status of the electrical device conforms with a specific condition further comprising:
determining whether the position status falls in an error range; and
determining the position status conforms with the specific condition when the position status falls in the error range.

5. The method according to claim 1, wherein when the position status of the electrical device conforms with a specific condition, further comprising:
determining whether the position status of the electrical device is the position status exceeds a period of time; and
executing the application corresponding to the specific angle when the position status of the electrical device is the position status exceeds a period of time.

6. The method according to claim 1, wherein the at least one sensor continues detects the position status of the electrical device when the position status of the electrical device conforms with a specific condition.

7. A system for activating an application, adapted to an electrical device, comprising:
at least one sensor for detecting a position status of the electrical device and outputting a sensing signal corresponding to the position status; and
a processor for determining the position status of the electrical device in response to the sensing signal, determining whether the position status of the electrical device conforms with a specific condition, and executing an application corresponding to the specific condition when the position status of the electrical device conforms with the specific condition.

8. The system according to claim 7, wherein the specific condition comprises the position status of the electrical device is a first angle, a second angle, a third angle, and a forth angle.

9. The system according to claim 8, wherein the angles respectively have a difference of ninety degrees.

10. The system according to claim 7, wherein the processor further determines whether the position status falls in an error range; and determines the position status conforms with the specific condition when the position status falls in the error range.

11. The system according to claim 7, wherein the processor further determines whether the position status of the electrical device is the position status exceeds a period of time and executes the application corresponding to the specific angle when the position status of the electrical device is the position status exceeds a period of time.

12. The system according to claim 7, wherein the at least one sensor continues to detect the position status of the electrical device when the position status of the electrical device conforms with a specific condition.

13. The system according to claim 7, wherein the at least one sensor is a G-sensor.

14. The system according to claim 7, wherein the at least one sensor further comprises a first sensor and a second sensor, both of which are connected to the processor respectively.

15. The system according to claim 14, wherein the first sensor is a G-sensor; the second sensor is a Gyroscope or a magnetism sensor.

16. The system according to claim 7, wherein the at least one sensor further comprises a first sensor, a second sensor, and a third sensor, all of which are connected to the processor respectively.

17. The system according to claim 16, wherein the first sensor is a G-sensor, the second sensor is a Gyroscope, and the third is a magnetism sensor.

18. A computer product for being loaded by a machine and executing a method for activating an application, the computer product comprising a first program code for detecting a position status of the electrical device using at least one sensor; a second program code for determining whether the position status of the electrical device conforms with a specific condition; and a third program code for executing an application corresponding to the specific condition when the position status of the electrical device conforms with the specific condition.
